(19) United States
(12) Patent Application Publication
(10) Pub. No.: US 2012/0109907 A1
(43) Pub. Date: May 3, 2012

(54) ON-DEMAND DATA DEDUPLICATION

(75) Inventors: Nagapramod S. Mandagere, San Jose, CA (US); David A. Pease, Redwood Estates, CA (US); Sandeep M. Uttamchandani, San Jose, CA (US); Pin Zhou, (US)

(73) Assignee: International Business Machines Corporation, Armonk, NY (US)

(21) Appl. No.: 12/916,524

(22) Filed: Oct. 30, 2010

(51) Int. Cl. G06F 17/30

(52) U.S. Cl. 707/692; 707/E17.005

(57) ABSTRACT

Embodiments of the invention relate to performing on-demand data deduplication for managing data and storage space. Redundant data in a system is detected. Availability of data storage space in the system is periodically evaluated. Performance parameters of the system are evaluated. Detected redundant data is selected based on the data storage availability and performance parameters of the system. If at least a portion of the selected redundant data is to be deduplicated is determined.

### BACKGROUND

The present invention relates generally to data deduplication, and more particularly, to performing on-demand data deduplication for managing data and storage space.

The amount of digital information, or data, stored is growing rapidly. Data growth is driven by many varied factors. One factor is that individual users are generating media and other content-rich data. Another factor that is contributing greatly to data growth, is the growing automation of enterprise processes. For example, in financial enterprises digitized images of bank documents such as withdrawal slips and other financial documentation can generate large amounts of data. In the medical field, significant amounts of documentation, such as medical records, patient x-rays, and other information are maintained online for sharing between hospitals, doctors offices, and other institutions, for example. As can be appreciated, there are numerous other enterprises were large amounts of data are stored both locally and online.

Also, a significant percentage of individual and enterprise data is now archived and backed-up to recover the data in case of disaster. There are also a growing number of regulatory compliance laws that contribute to data growth. For example, the Health Insurance Portability and Accountability Act (HIPAA) of 1996 requires the establishment of national standards for electronic health care transactions and national identifiers for providers, health insurance plans, and employers. The Sarbanes-Oxley Act of 2002 regulates the accounting practices of all United States public companies. This Act has set new or enhanced standards for all United States public company boards, management and public accounting firms pertaining to record retention and documentation standards. As can be seen, these acts as well as other audit laws both generate large amounts of data and require that the data to be retained for several years.

Data deduplication is a technology that helps enterprises reduce their data footprint by eliminating both intra-data object and inter-data object redundancy that commonly exists among stored data. For example, data deduplication can be used to reduce data in complete system backups. It can also be used in e-mail attachments where the same attachment is distributed to multiple users. Data deduplication is useful in software presentations where the presentation contains embedded images and the same embedded images are shared with numerous users. As can be appreciated, these system tasks, as well as numerous other tasks, can create large amounts of redundant data and data deduplication is useful for removing this redundant data.

However, the significant data footprint reduction achieved by data deduplication comes at a cost. Both performance and reliability are often traded for space savings. Performance degradation can come in the form of both reduced data write speed and data read performance. Write performance or data ingestion can be directly impacted if the data deduplication is done online in the data path. Based on the complexity of the deduplication algorithms used, for instance variable size chunking, write performance degradation may be quite severe. In the case of off-line data deduplication, where the deduplication is done in the background and time required for the data deduplication is not a substantial issue, the additional inputs and outputs can have an indirect impact on foreground traffic. For example, the re-reads from a drive, or system, or systems where the data being deduplicated and the additional write inputs and outputs can have an indirect impact on the foreground traffic and any power management schemes that might be in place when the system is performing the data deduplication.

Read performance can be also adversely affected data during deduplication. For example, simple data and file requests are translated by the deduplication layer into corresponding data, using metadata created during the deduplication process. During the data deduplication process, files and objects are typically broken down into variable sized chunks. These chunks are then stored as individual files on an underling file system. During the data deduplication process the sequential or contiguous nature of data in any file is often destroyed. Retrieval of a deduplicated data object requires the retrieval of all data chunks comprising that data object. Typically these chunks of data are not contiguous in terms of physical layout on a disk, for example, where they may be stored. Thus, several seeks or random accesses on disk are often performed to retrieve the data chunks of the data object being retrieved, which can result in long reconstruction times of the retrieved data object.

The impact on reliability is another issue of concern with data deduplication systems. Keeping only single instance for each data chunk magnifies the negative impact of losing data chunks, especially for common chunks shared by many data objects. For example, if a chunk that is shared by files is lost during data deduplication, the lost data chunk will adversely affect all of the files that share the chunk. As can be appreciated, adversely affecting 10 files is significantly worse than adversely affecting a single file.

### BRIEF SUMMARY

According to one general embodiment, a method for performing data deduplication. The method comprises detecting redundant data in a system, periodically evaluating availability of data storage space in the system, and evaluating performance parameters of the system. The method also comprises selecting detected redundant data based on the availability of data storage space and performance parameters of the system, and determining if at least a portion of the selected redundant data is to be deduplicated.

In another embodiment, a computer program product for performing on-demand data deduplication in a system. The computer program product comprises a computer readable storage medium having computer readable program code embodied therewith. The computer readable program code comprises computer readable program code configured to detect redundant data, computer readable program code configured to periodically evaluate availability of data storage space in the system, computer readable program code configured to evaluate performance parameters of the system. The computer readable program code also comprises computer readable program code configured to select redundant data based on the evaluated availability of data storage space and performance parameters of the system, and computer readable program code configured to determine if at least a portion of the selected redundant data is to be deduplicated.

In another embodiment a system that comprises a processor operative to execute computer usable program code, a memory for storing instructions operable with the processor, at least one of a network interface and a peripheral device interface for receiving user input and for sending and receiving data, a data storage for storing data coupled to the processor, and a computer usable medium having computer usable program code embodied therewith. The computer usable program code comprises computer usable program code configured to detect redundant data, computer readable program code configured to periodically evaluate availability data storage space in the system, computer readable program code configured to evaluate performance parameters of the system, and computer readable program code configured to select redundant data based on the evaluated availability of data storage space and performance parameters of the system. The computer usable program code comprises computer usable program code configured to determine if at least a portion of the selected redundant data is to be deduplicated.

Other aspects of the invention will become apparent from the following detailed description, which, when taken in conjunction with the drawings, illustrate by way of example the principles of the invention.

### BRIEF DESCRIPTION OF THE SEVERAL VIEWS OF THE DRAWINGS

For a fuller understanding of the nature and advantages of the invention, as well as a preferred mode of use, reference should be made to the following detailed description read in conjunction with the accompanying drawings, in which:

FIG. 1 illustrates a representative hardware environment in accordance with one embodiment.

FIG. 2 illustrates a high level block diagram of a method and apparatus for on demand data deduplication, in accordance with one embodiment.

FIG. 3 illustrates a flowchart representative of the operation of a method and apparatus for on demand data deduplication in accordance to one embodiment.

FIG. 4 illustrates a flowchart representative of the operation of the access of stored data in accordance to the present inventive material.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The embodiments described below disclose methods for on-demand data deduplication. The method comprises detecting redundant data in a system, periodically evaluating availability of data storage space in the system, and evaluating performance parameters of the system. The method also comprises selecting detected redundant data based on the availability of data storage space and performance parameters of the system, and determining if at least a portion of the selected redundant data is to be deduplicated.

In another embodiment, a computer program product for performing on-demand data deduplication in a system. The computer program product comprises a computer readable storage medium having computer readable program code embodied therewith. The computer readable program code comprises computer readable program code configured to detect redundant data, computer readable program code configured to periodically evaluate availability of data storage space in the system, computer readable program code configured to evaluate performance parameters of the system. The computer readable program code also comprises computer readable program code configured to select redundant data based on the evaluated availability of data storage space and performance parameters of the system, and computer readable program code configured to determine if at least a portion of the selected redundant data is to be deduplicated.

In another embodiment a system that comprises a processor operative to execute computer usable program code, a memory for storing instructions operable with the processor, at least one of a network interface and a peripheral device interface for receiving user input and for sending and receiving data, a data storage for storing data coupled to the processor, and a computer usable medium having computer usable program code embodied therewith. The computer usable program code comprises computer usable program code configured to detect redundant data, computer readable program code configured to periodically evaluate availability data storage space in the system, computer readable program code configured to evaluate performance parameters of the system, and computer readable program code configured to select redundant data based on the evaluated availability of data storage space and performance parameters of the system. The computer usable program code comprises computer usable program code configured to determine if at least a portion of the selected redundant data is to be deduplicated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

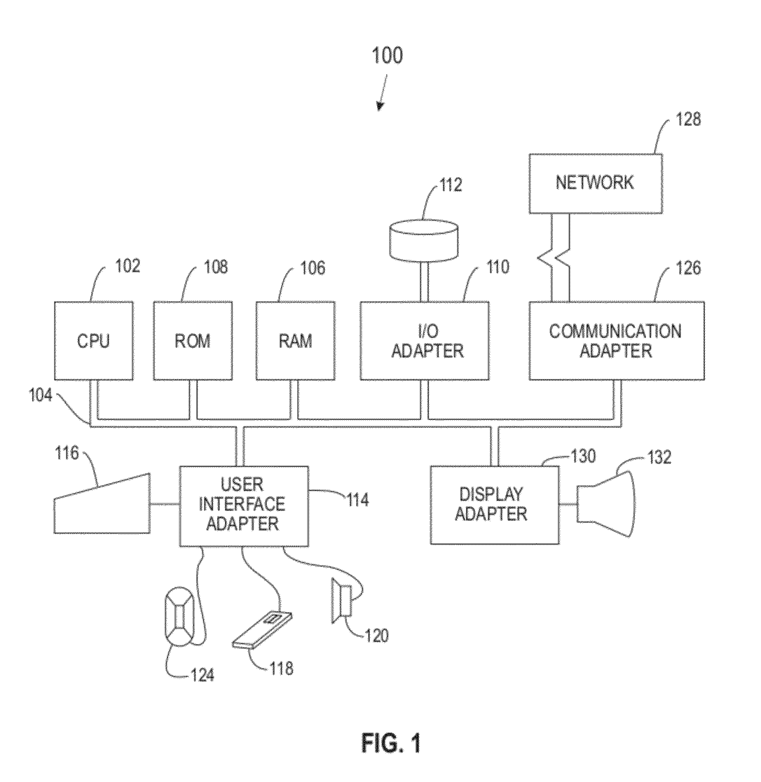

FIG. 1 shows a representative hardware environment associated with a user device 100 in accordance with one embodiment. The Figure illustrates a typical hardware configuration of a user device, or workstation 100, and/or server 100 that may include a central processing unit 102, such as a microprocessor, and a number of other devices interconnected via a system bus 104.

The workstation 100 shown in FIG. 1 includes a Random Access Memory (RAM) 106, Read Only Memory (ROM) 108, and an I/O adapter 110 for connecting peripheral devices such as disk storage units 112 to the bus 104. The workstation 100 also includes a user interface adapter 114 for connecting a keyboard 116, a mouse 124, a speaker 120, a microphone 118, and/or other user interface devices such as a touch screen and a digital camera (not shown) to the bus 104, a communication adapter 126 for connecting the workstation to a communication network 128 (e.g., a data processing network), and a display adapter 130 for connecting the bus 104 to a display device 132.

The workstation 100 may have resident thereon an operating system capable of running various programs. It will be appreciated that a preferred embodiment may also be implemented on any suitable platform or operating system. A preferred embodiment may be written using JAVA, XML, C, and/or C++ language, or other programming languages, along with an object oriented programming methodology. Object oriented programming (OOP), which has become increasingly used to develop complex applications, may be used.

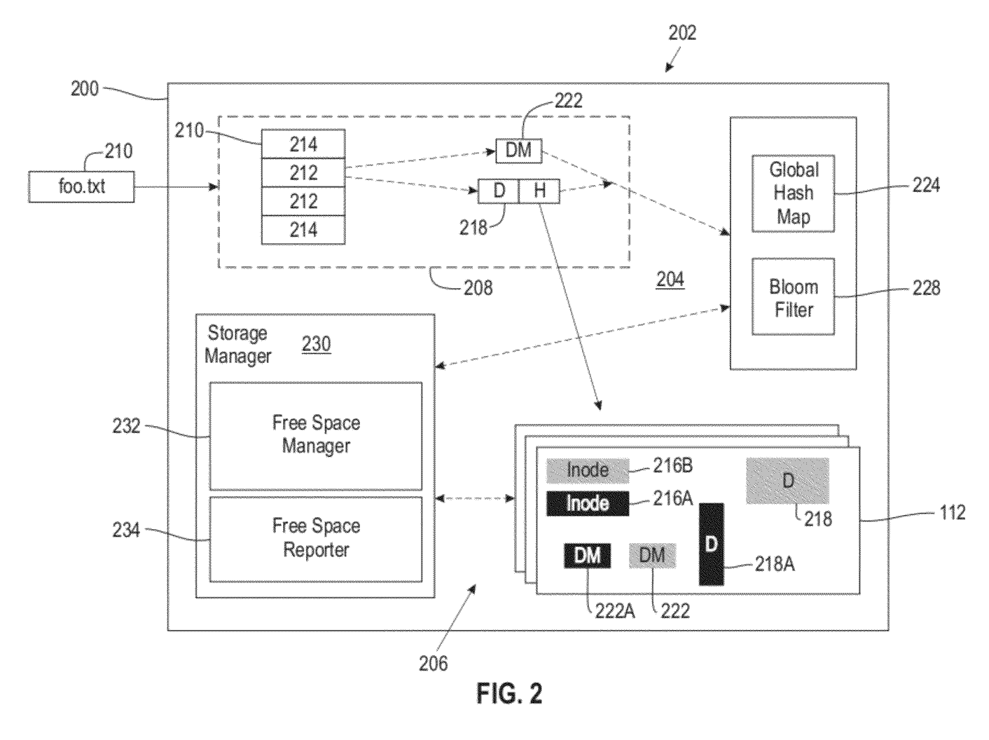

Referring to FIG. 2 of the drawings, there is shown generally at 200, an embodiment of a system running a data deduplication process 202. In one preferred embodiment, the system 200 may comprise a workstation 100, or similar environment, as discussed previously, suitable for running the data deduplication process 202. The data deduplication process 202 comprises an “on-demand” data deduplication process, where redundant data is selectively deduplicated only when an amount of free storage space available on a data storage medium, such as the disk storage units 112, falls below a predetermined threshold (to be thoroughly discuss hereinafter). By only selectively deduplicating redundant data when storage space is needed, the performance and reliability issues of known deduplication systems are alleviated.

In one embodiment, the data deduplication process 202 is separated into two general phases, redundant data detection 204 and redundant data elimination 206. Redundant data detection 204 is performed on an ongoing basis, while redundant data elimination 206 is delayed until necessary. By separating the deduplication process 100 into the redundant data detection 106 and redundant data elimination 108 phases, and only selectively deduplicating redundant data when storage space is needed, the performance and reliability of the system 200 running the data deduplication process 100 are not adversely effected.

A redundant data detector 208 is provided to detect redundant data. In one embodiment, the redundant data detector 208 detects redundant data online. In another embodiment, the redundant data detector 208 detects redundant data, when data is ingested by the system 200. In an alternative embodiment, the redundant data detector 208 evaluates data that is stored on the storage units 112 of the system 200. In a preferred embodiment, the redundant data detector 208 detects redundant data as the data is ingested by the system 200 and detects redundant data for data that is stored on the storage units 112.

The disk storage units 112 may comprise any suitable known data storage medium discussed previously, including the following: portable computer diskettes, hard disk drives, and erasable programmable read-only memory (EPROM or Flash memory), among numerous computer readable data storage medium(s). In one preferred embodiment the disk storage units 112 may comprise a computer hard disk drive or array of hard disk drives that may comprise both physical and logical volumes.

Referring still to FIG. 1, in one embodiment, the redundant data detector 208 receives data that may be in the form of data files or objects 210. The data files or objects 210 may comprise any type of data that is readable and/or writable by the system 200. The data objects and/or data files 210 may include, but are not limited to, computer readable and writable files, document files, and text files, among numerous known and suitable file types.

In process, a file foo.txt 210 is detected by the redundant data detector 208 for determining if the file foo.txt 210 contains redundant data chunk 212 either in itself or in already stored data. The file foo.txt 210 may contain both redundant data 212 and “non-redundant” data such as 214. Initially, the file foo.txt 210 is detected by the redundant data detector 208 and then written to and stored as a contiguous file 218A on the storage units 112, and the deduplication metadata 222A for the file foo.txt 210 is also stored on the storage units 112. The inode 216A stores basic information about the file 210, such as a directory and other file information as is known in the art. The inode 216A in combination with the deduplicaiton metadata 222A can used to retrieve information regarding the file 210, to reconstruct the file 210, when the file 210 is accessed at a later time.

In one embodiment, the file 210 is chunked using chunk based duplication techniques. These chunk based duplication techniques can include variable size hash or fixed size hash, among other chunk based duplication techniques. In one preferred embodiment, the file 210 is logically chunked, instead of physically chunked, by the redundant data detector 208 into extents 218A. A hash value 220 for the extents is generated, and the deduplication metadata 222A that are associated with the extents 218A are also created. The hash values 220 of the extents 218A are then recorded into a global hash map 224, which may reside in memory 108 or on storage units 112. In the embodiment, each hash value 220 recorded in the hash map 224 can map to multiple extent IDs. Hash values 220 that map to multiple extent IDs correspond to redundant extents 218A, indicating redundant data 212 that have a same hash value 220. In known data deduplication techniques, each hash value recorded in a hash map corresponds to only one extent.

As files 210 are detected by the redundant data detector 208, the process is repeated and the hash map 224 is continuously updated. Along with updating the hash map 224, the redundant data detector 208 also creates and stores identified extent boundaries per file, or Deduplication Metadata (DM) 222A for future use.

In one embodiment, if it is determined that the amount of free space available on the storage units 112 is below a predetermined threshold, the redundant data detector 208 is invoked for detecting and suppressing redundant data 212 (to be discussed thoroughly hereinafter) to increase the available storage space on the storage units 112. The redundant data 212 is suppressed, as “suppressed data object(s)” or “suppressed object(s)” 226, to remove the redundant data 212. An entire file 210 may comprise redundant data 212 and may be suppressed. Once suppressed, the file 210 is marked in the Bloom Filter/suppressed object table 228. When a file 210 is accessed at a later time, the system 200 first accesses the Bloom Filter/suppressed object table 228 to determine if all or any portion of the data comprising the file 210 is suppressed. If all or any portion of the data the file 210 is suppressed, the file 210 is reconstructed using its deduplication metadata 222A and the corresponding extents. If the file 210 is not suppressed or does not contain any suppressed data, the file 210 is accessed through the inode 216A for that file 210 and reconstructed.

In one embodiment, the suppressed object table 228 comprises a probabilistic data structure to aid in the speed and efficiency of searching the suppressed object table 228 and determining if the file 210 is a suppressed extent 218A and/or contains suppressed extents 218A. In one embodiment, the probabilistic data structure comprising the suppressed object table 228 comprises a space efficient data structure, such as an array, that is used to test whether an element is a member of a set or not. The probabilistic data structure comprising the suppressed object table 228 also may generate false positives, but not false negatives. The probabilistic data structure may also allow elements to be added to a set, but not removed. In one preferred embodiment, the probabilistic data structure comprising the suppressed object table 228 comprises a Bloom Filter.

Still referring to FIG. 2, in one embodiment, a storage manager 230 is provided for monitoring the amount of free space available on the disk storage units 112. In a preferred embodiment, the storage manager 230 includes a free space manger 232 and a free space reporter 234.

The free space manger 232 monitors the amount of free space available on the disk storage units 112 and invokes the redundant data detector 208 for detecting and suppressing the redundant data 212. If the amount of free space available on the storage units 112 falls below a predetermined available storage space threshold, the free space manger 232 invokes the redundant data detector 208 for detecting and suppressing the redundant data 212. Alternatively, the free space manger 232 may invoke the redundant data detector 208 based on one or more predefined storage availability policies.

In one embodiment, the storage availability policies may evaluate several factors of the stored redundant extents 218A for selecting extents for removal. The storage policy may be adjusted and modified from application to application or in real time based on policy concerns, as well as treat certain redundant data chunks 218A in a preferential manner. For example, some redundant data extents may be so valuable that they are not to be removed no matter how many copies or duplicates exist because their loss or corruption could greatly impact the system's integrity and functionality.

Factors that the storage availability policies may evaluate for selecting redundant extents 218A to removal may include, for example, minimum free storage availability thresholds, a reference count of extents, the spatial data correlation between related extents, and the data object status, for example. The data object status indicates if the extent is a suppressed extent or a non-suppressed extent.

In one embodiment, the free space reporter 232 is provided to determine and report the storage space available on the storage units 112. In a preferred embodiment, the free space reporter 232 is configured to determine available storage space and generate an “opportunistic free space” report. In an optional embodiment, the free space reporter 232 is configured to determine available storage space and generate an “maximum free space” report, in addition to and/or in lieu of the opportunistic free space report.

In a preferred embodiment, the free space reporter 232 determines available storage space and generates the opportunistic free space report, based on the redundancy policy definitions, such as a minimal number of duplicated copies in the system or the maximum suppression ratio, and the global hash map 224. For determining the maximum free space report, the free space reporter 232 uses single instance deduplication, were deduplication duplicative, or repetitive data, is removed once it is detected. Single instance deduplication typically creates a maximum amount of free space on the storage units 112, but may suffer from the various disadvantages mentioned previously. Single instance deduplication yields a theoretical amount of storage space and the user is made aware of the theoretical amount of storage space and the actual storage space available on the storage units 112. This allows a user to adjust or modify the storage policies as needed, trading off data integrity risks and maximum storage efficiency.

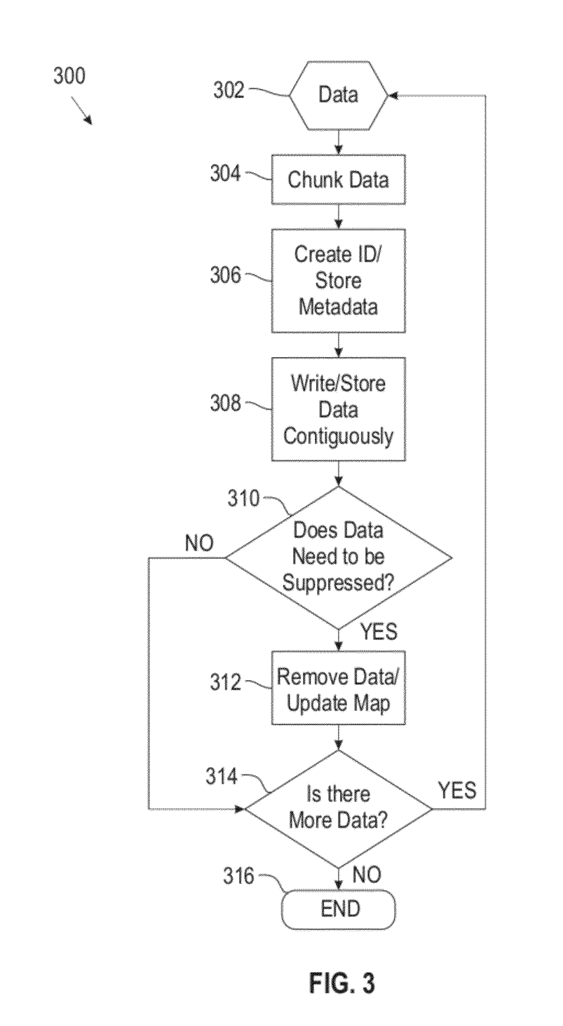

Referring to FIG. 2 and FIG. 3, there is shown an exemplary embodiment of a method 300 of on-demand deduplication process in FIG. 2. In step 302 of the method 300, the redundant data detector 208 detects redundant data 212. In a preferred embodiment, the redundant data detector 208 detects redundant data, both as the data is ingested by the system 200 and redundant data that is stored on the storage units 112. In step 304, the duplication detector 200 logically chunks a file 210 into extents. The hash value 220 for the extents is generated and recorded into the global hash map 224, and the extent IDs 222, corresponding to the extents are also created and stored, in step 306 of the method 300. In step 308, the file 210 is written to and stored as a contiguous file on the storage units 112 via an inode 216A. Writing the file 210 as a single contiguous data object on the storage units 112 allows the file 210 to be reconstructed more quickly than if the data comprising the file 210 were not stored contiguously.

In decision block 310 of the method 300, the free space manger 232 monitors the amount of free space available on the disk storage units 112 and invokes the duplication detector 208 if the amount of free space available on the storage units 112 falls below a predetermined available storage space threshold. If the amount of free space available on the storage units 112 is below a predetermined available storage space threshold, the method 300 continues to step 312, where redundant data 218A is selectively suppressed as discussed previously and the hash map 224 is updated. In decision block 314, the redundant data detector 208 determines if there are additional files 210 or data to detect. If there currently is more data and/or files 210 to detect, the method 300 returns to step 302. If there currently is not more data and/or files 210 to detect, the method 300 ends at end block 316.

Returning to decision block 310 of the method 300, if the free space manger 232 determines that the amount of free space available on the storage units 112 is above a predetermined available storage space threshold, then the method continues to decision block 314. In decision block 314, the redundant data detector 208 determines if there are additional files 210 or data to detect. If there currently is more data and/or files 210 to detect, the method 300 returns to step 302. If there currently is not more data and/or files 210 to detect, the method 300 ends at end block 316.

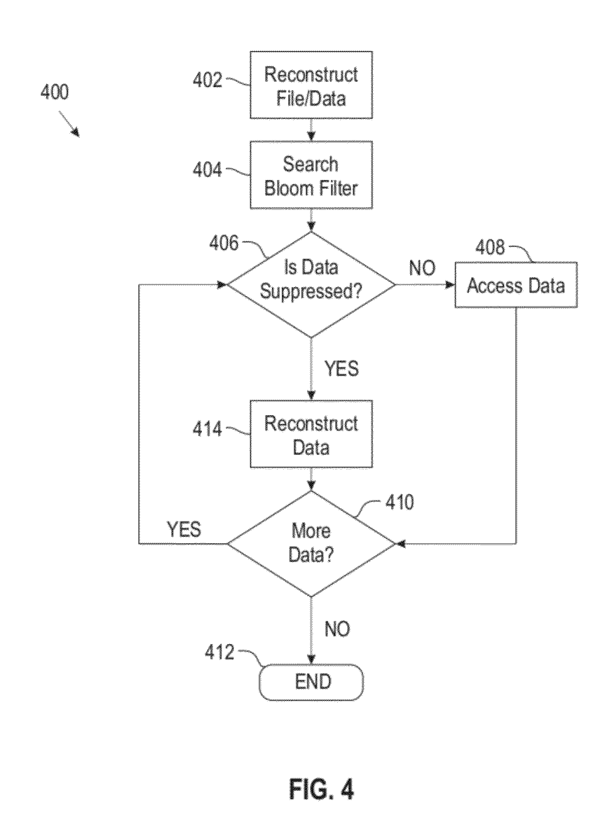

Referring to FIG. 1 and FIG. 4, there is shown an exemplary embodiment of a method 400 for retrieving and/or accessing stored data. In step 402 a file 210 to be reconstructed is selected and in step 404 the suppressed object table 238 is searched. In decision block 406 it is determined, by searching the suppressed object table 238, if any portion of the data comprising a file 210 to be retrieved is suppressed. If no portion of the data comprising the file 210 has been suppressed, then the method 400 continues to step 408. In step 408, the data comprising the file 210 is accessed through the inode 216A for that file 210 and the file 210 is reconstructed. The method 400 then continues to decision block 410, where it is determined if there are additional files 210 or data to detect. If there currently is more data and/or files 210 to detect, the method 400 returns to step 406. If there currently is not more data and/or files 210 to detect, the method 400 ends at end block 412.

Returning to decision block 406 of the method 400, if the any portion of the data comprising the file 210 is suppressed, the method continues to process block 414. In process block 414, the file 210 is reconstructed using its extents 218A and extent IDs that are recorded in the hash map 224 and the file 210 is reconstructed. The method 400 then continues to decision block 410, where it is determined if there are additional files 210 or data to detect. If there currently is more data and/or files 210 to detect, the method 400 returns to step 406. If there currently is not more data and/or files 210 to detect, the method 400 ends at end block 412.

Those skilled in the art will appreciate that various adaptations and modifications can be configured without departing from the scope and spirit of the embodiments described herein. Therefore, it is to be understood that, within the scope of the appended claims, the embodiments of the invention may be practiced other than as specifically described herein.

What is claimed is:

1. A method comprising:
detecting redundant data in a system;
periodically evaluating availability of data storage space in the system;
evaluating performance parameters of the system;
selecting detected redundant data based on the availability of data storage space of the system; and
determining if at least a portion of the selected redundant data is to be deduplicated.

2. The method of claim 1 further comprising:
wherein determining if at least a portion of the selected redundant data is to be deduplicated comprises:
determining the availability of data storage in the system; and
determining the performance of the system; and
if availability of data storage in the system is less than a predetermined value and if the performance of the system is greater than a predetermined value, then deduplicating at least a portion of the selected redundant data.

3. The method of claim 1 further comprising:
wherein redundant data in the system comprises:
detecting data as data is ingested by the system for determining if the ingested data is redundant data; and
detecting data stored in the system for determining if the data stored in the system is redundant data.

4. The method of claim 2 further comprising:
wherein deduplicating at least a portion of the selected redundant data comprises:
deduplicating redundant data in the system by logically chunking redundant data into data extents.

5. The method of claim 4 further comprising:
assigning a hash value and an extent identification to each data extent; and
recording the hash value, the extent identification, and an extent boundary for each data extent into a hash map, wherein at least one recorded hash value in the hash map corresponds to more than one data extent identification.

6. The method of claim 5 further comprising:
wherein a recorded hash value in the hash map corresponding to more than one data extent identification corresponds to redundant data extents, the redundant data extents corresponding to redundant data.

7. The method of claim 1 further comprising:
removing a data object from redundant data, the removed data object comprising a suppressed data object; and
recording suppressed data objects in a probabilistic data structure, the data structure configured for determining if data objects are suppressed data objects.

8. The method of claim 7 further comprising:
selecting a data object to be accessed;
searching the probabilistic data structure for determining if the selected data object is a suppressed data object; and
if the selected data object is a suppressed data object, then retrieving data extents comprising the selected data object and reconstructing the selected data object.

9. A computer program product comprising:
a computer readable storage medium having computer readable program code embodied therewith, the computer readable program code comprising:
computer readable program code configured to detect redundant data;
computer readable program code configured to periodically evaluate availability of data storage space in the system;
computer readable program code configured to periodically evaluate performance parameters of the system;
computer readable program code configured to select redundant data based on the evaluated availability of data storage space and performance parameters of the system; and
computer readable program code configured to determine if at least a portion of the selected redundant data is to be deduplicated.

10. The computer program product of claim 9 further comprising:
computer readable program code configured to determine if availability of data storage space in the system is determined to be less than a predetermined value and if the performance of the system is determined to be greater than a predetermined value, then the computer readable program code deduplicates at least a portion of the selected redundant data.

11. The computer program product of claim 9 further comprising:
computer readable program code configured to detect data as data is ingested by the system for determining if the data being ingested is redundant data; and
computer readable program code configured to detect data stored in the system for determining if the data stored in the system is redundant data.

12. The computer program product of claim 9 further comprising:
computer readable program code configured to deduplicate redundant data in the system by logically chunking redundant data into data extents.

13. The computer program product of claim 10 further comprising:
computer readable program code configured to assign a hash value and an extent identification to each data extent; and
computer readable program code configured to record the hash value, the extent identification, and an extent boundary for each data extent into a hash map, wherein at least one recorded hash value in the hash map corresponds to more than one data extent identification, wherein a recorded hash value in the hash map corresponding to more than one data extent identification corresponds to redundant data extents, the redundant data extents corresponding to redundant data.

14. The computer program product of claim 9 further comprising:
computer readable program code configured to remove a data object from redundant data, the removed data object comprising a suppressed data object; and
computer readable program code configured to record suppressed data objects in a probabilistic data structure, the data structure configured to determine if data objects are suppressed data objects.

15. The computer program product of claim 14 further comprising:
computer readable program code configured to select a data object to be accessed;
computer readable program code configured to search the probabilistic data structure to determine if the selected data object is a suppressed data object; and
computer readable program code configured to determine if the selected data object is a suppressed data object, the computer readable program code configured to retrieve data extents comprising the selected data object and reconstructing the selected data object.

17. A system comprising:
a processor operative to execute computer usable program code;
a memory for storing instructions operable with the processor;
at least one of a network interface and a peripheral device interface for receiving user input and for sending and receiving data;
a data storage for storing data coupled to the processor; and
a computer usable medium having computer usable program code embodied therewith, the computer usable program code comprising:
computer usable program code configured to detect redundant data;
computer readable program code configured to periodically evaluate availability data storage space in the system;
computer readable program code configured to evaluate performance parameters of the system;
computer readable program code configured to select redundant data based on the evaluated availability of data storage space and performance parameters of the system; and
computer readable program code configured to determine if at least a portion of the selected redundant data is to be deduplicated.

18. The system of claim 17 further comprising:
computer readable program code configured to determine the availability of data storage space in the system and to determine the performance of the system; and
computer readable program code configured to determine if availability of data storage space in the system is determined to be less than a predetermined value and if the performance of the system is determined to be greater than a predetermined value, then the computer readable program code deduplicates at least a portion of the selected redundant data.

19. The system of claim 17 further comprising:
computer readable program code configured to deduplicate redundant data in the system by logically chunking redundant data into data extents;
computer readable program code configured to assign a hash value and an extent identification to each data extent; and
computer readable program code configured to record the hash value, the extent identification, and an extent boundary for each data extent into a hash map, wherein at least one recorded hash value in the hash map corresponds to more than one data extent identification, wherein a recorded hash value in the hash map corresponding to more than one data extent identification corresponds to redundant data extents, the redundant data extents corresponding to redundant data in the system.

20. The system of claim 17 further comprising:
computer readable program code configured to remove a data object from redundant data, the removed data object comprising a suppressed data object;
computer readable program code configured to record suppressed data objects in a probabilistic data structure, the data structure configured to determine if data objects are suppressed data objects.
computer readable program code configured to select a data object to be accessed;
computer readable program code configured to search the probabilistic data structure to determine if the selected data object is a suppressed data object; and
computer readable program code configured to determine if the selected data object is a suppressed data object, the computer readable program code configured to retrieve data extents comprising the selected data object and reconstructing the selected data object.
